(19) United States
(12) Patent Application Publication
(10) Pub. No.: US 2026/0285307 A1
(43) Pub. Date: Sep. 24, 2026

(54) FOOTREST USING ACCELERATOR PEDAL FOR VEHICLES IN CRUISE CONTROL

(71) Applicant: GM GLOBAL TECHNOLOGY OPERATIONS LLC, Detroit, MI (US)

(72) Inventors: Chulho Song, Mapo-gu (KR); Bongbum Back, Incheon (KR); Seokju Yong, Bucheon-si (KR); Minseok Jeon, Gimpo-si (KR)

(73) Assignee: GM GLOBAL TECHNOLOGY OPERATIONS LLC, Detroit, MI (US)

(21) Appl. No.: 19/084,426

(22) Filed: Mar. 19, 2025

(51) Int. Cl. B60W 30/14; B60W 50/08

(52) U.S. Cl. CPC B60W 30/146; B60W 50/082; B60W 2540/043; B60W 2540/103; B60W 2540/12; B60W 2540/215

(57) ABSTRACT

In exemplary embodiments, methods and systems are provided that include obtaining, via input sensors of a vehicle, inputs from a driver as to initiation of a cruise control feature and a free legroom feature for the vehicle; obtaining, via one or more accelerator pedal sensors coupled to an accelerator pedal of the vehicle, a measure of engagement of the accelerator pedal by the driver; and selectively controlling, via a processor of the vehicle based on the inputs and the measure of engagement of the accelerator pedal, a response of a drive system of the vehicle to the engagement of the accelerator pedal when the cruise control feature and the free legroom feature of the vehicle are both activated based on the inputs, such that a speed of the vehicle will not increase based on the engagement of the accelerator pedal that is less than a predetermined threshold.

### INTRODUCTION

The technical field generally relates to vehicles and, more specifically, to methods and systems for implementing cruise control for vehicles.

Certain vehicles today are equipped with cruise control, including in some vehicles adaptive cruise control, in which the vehicle automatically adjusts its speed in maintaining a distance from other vehicles.

Accordingly, it is desirable to provide improved methods and systems for implementing cruise control functionality, including adaptive cruise control, and including for facilitating driver comfort during adaptive cruise control. Furthermore, other desirable features and characteristics of the present disclosure will become apparent from the subsequent detailed description and the appended claims, taken in conjunction with the accompanying drawings and the foregoing technical field and background.

### SUMMARY

In an exemplary embodiment, a method is provided that includes obtaining, via one or more input sensors of a vehicle, inputs from a driver as to initiation of a cruise control feature and a free legroom feature for the vehicle; obtaining, via one or more accelerator pedal sensors coupled to an accelerator pedal of the vehicle, a measure of engagement of the accelerator pedal by the driver; and selectively controlling, via a processor of the vehicle based on the inputs and the measure of engagement of the accelerator pedal, a response of a drive system of the vehicle to the engagement of the accelerator pedal when the cruise control feature and the free legroom feature of the vehicle are both activated based on the inputs, such that a speed of the vehicle will not increase based on the engagement of the accelerator pedal that is less than a predetermined threshold.

Also in an exemplary embodiment, the cruise control feature includes adaptive cruise control for the vehicle.

Also in an exemplary embodiment, the predetermined threshold includes a predetermined travel threshold for accelerator pedal travel of the accelerator pedal; when the accelerator pedal travel exceeds the predetermined travel threshold, a signal output for the accelerator pedal increases, such that the speed of the vehicle increases as a result of the engagement of the accelerator pedal by the driver; and when the accelerator pedal travel does not exceed the predetermined travel threshold, the signal output for the accelerator pedal remains constant, such that the speed of the vehicle does not increase, and the driver can rest a leg on the accelerator pedal during the adaptive cruise control.

Also in an exemplary embodiment, the method further includes tuning, via the processor, the predetermined travel threshold based on the inputs provided by the driver and obtained via the one or more input sensors for settings for the free legroom feature of the adaptive cruise control.

Also in an exemplary embodiment, the free legroom feature activates via instructions provided by the processor when an input sensor push button is pressed for more than three seconds.

Also in an exemplary embodiment, the method further includes storing the settings for the driver into memory, via the processor, along with information for identification of the driver, for use in subsequent vehicle drives.

Also in an exemplary embodiment, the predetermined threshold includes a predetermined force threshold for accelerator pedal force of the accelerator pedal; when the accelerator pedal force exceeds the predetermined force threshold, a signal output for the accelerator pedal increases, such that the speed of the vehicle increases as a result of the engagement of the accelerator pedal by the driver; and when the accelerator pedal force does not exceed the predetermined force threshold, the signal output for the accelerator pedal remains constant, such that the speed of the vehicle does not increase, and the driver can rest a leg on the accelerator pedal during the adaptive cruise control.

Also in an exemplary embodiment, the method further includes tuning, via the processor, the predetermined force threshold based on the inputs provided by the driver and obtained via the one or more input sensors for settings for the free legroom feature of the adaptive cruise control; and storing the settings for the driver into memory, via the processor, along with information for identification of the driver, for use in subsequent vehicle drives.

Also in an exemplary embodiment, the method further includes disengaging the free legroom feature, via the processor, upon occurrence of one or more of the following conditions: (i) the driver has turned off or deactivated the adaptive cruise control; (ii) the driver has engaged a brake pedal of the vehicle; (iii) the driver has engaged the accelerator pedal by an amount that is more than the predetermined threshold amount resulting in accelerator pedal travel that is greater than a predetermined pedal travel threshold; or (iv) the driver has engaged the accelerator pedal for greater than a predetermined number of engagements within an amount of time that is less than a predetermined duration of time.

In another exemplary embodiment, a system is provided that includes one or more input sensors of a vehicle that are configured to obtain inputs from a driver as to initiation of a cruise control feature and a free legroom feature for the vehicle; one or more accelerator pedal sensors that are coupled to an accelerator pedal of the vehicle and that are configured to obtain a measure of engagement of the accelerator pedal by the driver; and a processor of the vehicle that is coupled to the one or more input sensors and to the one or more accelerator pedal sensors, and that is configured to at least facilitate selectively controlling, based on the inputs and the measure of engagement of the accelerator pedal, a response of a drive system of the vehicle to the engagement of the accelerator pedal when the cruise control feature and the free legroom feature of the vehicle are both activated based on the inputs, such that a speed of the vehicle will not increase based on the engagement of the accelerator pedal that is less than a predetermined threshold.

Also in an exemplary embodiment, the cruise control feature includes adaptive cruise control for the vehicle.

Also in an exemplary embodiment, the predetermined threshold includes a predetermined travel threshold for accelerator pedal travel of the accelerator pedal; when the accelerator pedal travel exceeds the predetermined travel threshold, the processor is configured to at least facilitate increasing a signal output for the accelerator pedal, such that the speed of the vehicle increases as a result of the engagement of the accelerator pedal by the driver; and when the accelerator pedal travel does not exceed the predetermined travel threshold, the processor is configured to at least facilitate keeping the signal output for the accelerator pedal constant, such that the speed of the vehicle does not increase, and the driver can rest a leg on the accelerator pedal during the adaptive cruise control.

Also in an exemplary embodiment, the free legroom feature activates via instructions provided by the processor when an input sensor push button is pressed for more than three seconds.

Also in an exemplary embodiment, the processor is further configured to at least facilitate tuning the predetermined travel threshold based on the inputs provided by the driver and obtained via the one or more input sensors for settings for the free legroom feature of the adaptive cruise control.

Also in an exemplary embodiment, the processor is further configured to at least facilitate storing the settings for the driver into memory along with information for identification of the driver, for use in subsequent vehicle drives.

Also in an exemplary embodiment, the predetermined threshold includes a predetermined force threshold for accelerator pedal force of the accelerator pedal; when the accelerator pedal force exceeds the predetermined force threshold, the processor is configured to at least facilitate increasing a signal output for the accelerator pedal, such that the speed of the vehicle increases as a result of the engagement of the accelerator pedal by the driver; and when the accelerator pedal force does not exceed the predetermined force threshold, the processor is configured to at least facilitate keeping the signal output for the accelerator pedal constant, such that the speed of the vehicle does not increase, and the driver can rest a leg on the accelerator pedal during the adaptive cruise control.

Also in an exemplary embodiment, the processor is further configured to at least facilitate tuning the predetermined force threshold based on the inputs provided by the driver and obtained via the one or more input sensors for settings for the free legroom feature of the adaptive cruise control; and storing the settings for the driver into memory, along with information for identification of the driver, for use in subsequent vehicle drives.

Also in an exemplary embodiment, the processor is further configured to at least facilitate disengaging the free legroom feature, upon occurrence of one or more of the following conditions: (i) the driver has turned off or deactivated the adaptive cruise control; (ii) the driver has engaged a brake pedal of the vehicle; (iii) the driver has engaged the accelerator pedal by an amount that is more than the predetermined threshold amount resulting in accelerator pedal travel that is greater than a predetermined pedal travel threshold; or (iv) the driver has engaged the accelerator pedal for greater than a predetermined number of engagements within an amount of time that is less than a predetermined duration of time.

In another exemplary embodiment, a vehicle is provided that includes a body; a drive system configured to move the body; an accelerator pedal coupled to the drive system; one or more input sensors that are configured to obtaining inputs from a driver as to initiation of an adaptive cruise control and a free legroom feature for the vehicle; one or more accelerator pedal sensors that are coupled to the accelerator pedal and that are configured to obtain a measure of engagement of the accelerator pedal by the driver; and a processor of the vehicle that is coupled to the one or more input sensors and to the one or more accelerator pedal sensors, and that is configured to at least facilitate selectively controlling, based on the inputs and the measure of engagement of the accelerator pedal, a response of the drive system to the engagement of the accelerator pedal when the adaptive cruise control and the free legroom feature of the vehicle are both activated based on the inputs, such that a speed of the vehicle will not increase based on the engagement of the accelerator pedal that is less than a predetermined threshold, wherein: the predetermined threshold includes a predetermined travel threshold for accelerator pedal travel of the accelerator pedal; when the accelerator pedal travel exceeds the predetermined travel threshold, the processor is configured to at least facilitate increasing a signal output for the accelerator pedal, such that the speed of the vehicle increases as a result of the engagement of the accelerator pedal by the driver; and when the accelerator pedal travel does not exceed the predetermined travel threshold, the processor is configured to at least facilitate keeping the signal output for the accelerator pedal constant, such that the speed of the vehicle does not increase, and the driver can rest a leg on the accelerator pedal during the adaptive cruise control.

Also in an exemplary embodiment, the processor is further configured to at least facilitate tuning the predetermined travel threshold based on the inputs provided by the driver and obtained via the one or more input sensors for settings for the free legroom feature of the adaptive cruise control; storing the settings for the driver into memory along with information for identification of the driver, for use in subsequent vehicle drives; and disengaging the free legroom feature, upon occurrence of one or more of the following conditions: (i) the driver has turned off or deactivated the adaptive cruise control; (ii) the driver has engaged a brake pedal of the vehicle; (iii) the driver has engaged the accelerator pedal by more than a predetermined threshold amount resulting in the accelerator pedal travel that is greater than a predetermined pedal travel threshold; or (iv) the driver has engaged the accelerator pedal for greater than a predetermined number of engagements within an amount of time that is less than a predetermined duration of time.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for controlling cruise control functionality, and including for driver leg comfort during adaptive cruise control, in accordance with exemplary embodiments;

FIG. 2 is a diagram of a portion of the vehicle of FIG. 1 as implemented in connection with cruise control functionality, in accordance with exemplary embodiments;

FIG. 3 is a flowchart of a process for controlling cruise control in a vehicle, including for driver leg comfort during adaptive cruise control, and that can be implemented in connection with the vehicle and control system of FIG. 1 and the implementation of FIG. 2, in accordance with exemplary embodiments;

FIG. 4 is a flow diagram of a subroutine of the process of FIG. 3, in accordance with exemplary embodiments, namely of adjusting comfort settings for the driver for adaptive cruise control, in accordance with exemplary embodiments; and

FIGS. 5-8 depict exemplary implementations of the process of FIGS. 3-4, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

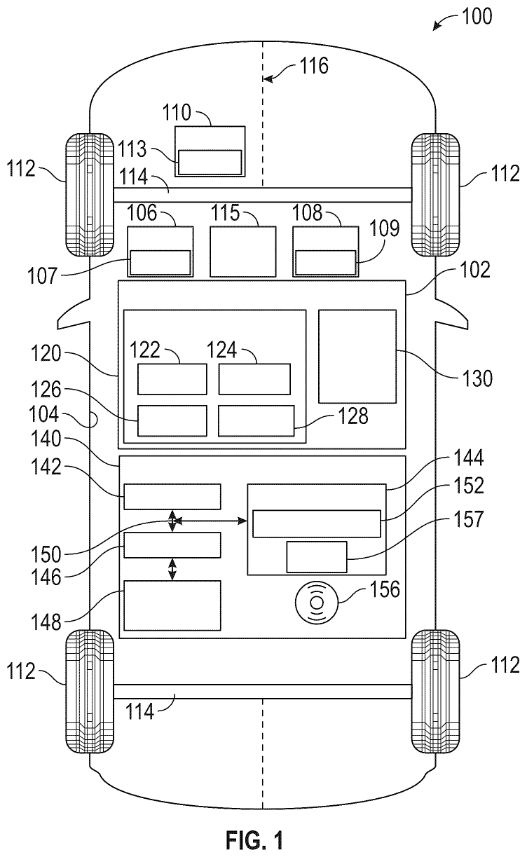

FIG. 1 illustrates a vehicle 100, according to an exemplary embodiment. As described in greater detail further below, the vehicle 100 includes a control system 102 that is configured for controlling cruise control functionality for the vehicle 100, including driver comfort for adaptive cruise control, in accordance with exemplary embodiments. Specifically, in various embodiments and as described in greater detail further below, the control system 102 allows the driver to utilize an accelerator pedal 115 of the vehicle 100 for leg and foot rest while using cruise control for the vehicle 100, including while using adaptive cruise control for an extended period of time.

In various embodiments, the vehicle 100 includes an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise another type of vehicle, such as aircraft, spacecraft, watercraft, and so on.

The vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks and certain other vehicles).

As depicted in FIG. 1, the vehicle includes a braking system 106 that controls braking of the vehicle 100 using braking components that are controlled via inputs provided by a driver (e.g., via a brake pedal 107) and that are also automatically controlled via the control system 102 in certain situations such as during cruise control operation.

In exemplary embodiments, the vehicle 100 also includes a steering system 108 that controls steering of the vehicle 100. In various embodiments, the steering system 108 controls steering of the vehicle 100 via steering components, for example that including a steering column that is coupled to the axles 114 and/or the wheels 112, and that is controlled via inputs provided by a driver via a steering wheel 109.

Also in exemplary embodiments, a drive system 110 is mounted on the chassis 116, and drives the wheels 112, for example via axles 114. In certain embodiments, the drive system 110 comprises a propulsion system. In certain exemplary embodiments, the drive system 110 comprises a motor 113, such as an internal combustion engine and/or an electric motor/generator, coupled with a transmission thereof. In certain embodiments, the drive system 110 may vary, and/or two or more drive systems 110 may be used. Also in exemplary embodiments, the drive system 110 controls propulsion of the vehicle 100 in accordance with via inputs provided by a driver (i.e., via the above-referenced accelerator pedal 115), and that are also automatically controlled via the control system 102 in certain situations such as in cruise control operation.

In the embodiment depicted in FIG. 1, the control system 102 is coupled to the braking system 106 and the drive system 110. In certain embodiments, the control system 102 may also be coupled to the steering system 108 and/or one or more other vehicle systems and/or components.

In various embodiments, as noted above, the control system 102 controls cruise control functionality for the vehicle 100, including adaptive cruise control. In various embodiments, cruise control includes automatically controlling speed via the control system 102. Also in various embodiments, a standard cruise control functionality maintains a predetermined speed for the vehicle 100, whereas an adaptive cruise control functionality maintains a predetermined distance or time between the vehicle 100 and other vehicles by automatically adjusting the vehicle speed accordingly via the control system 102.

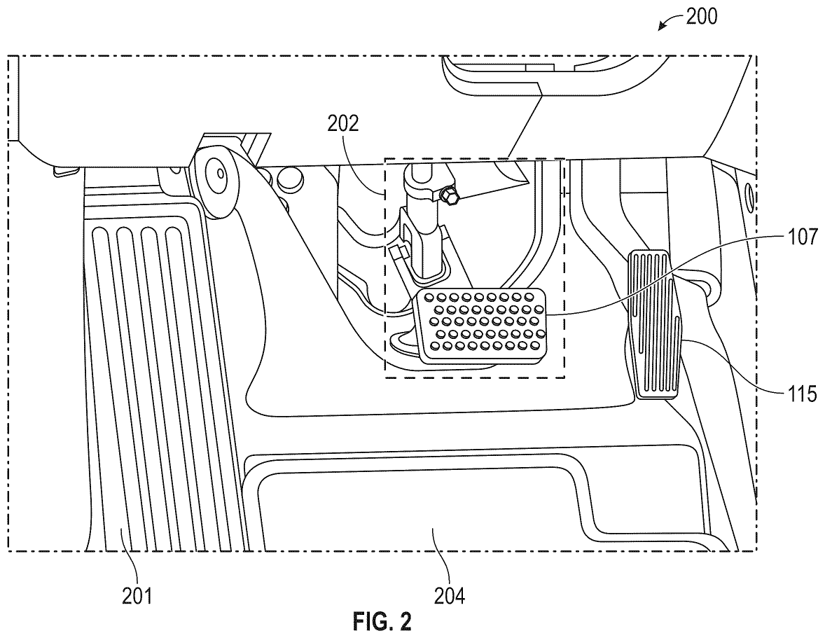

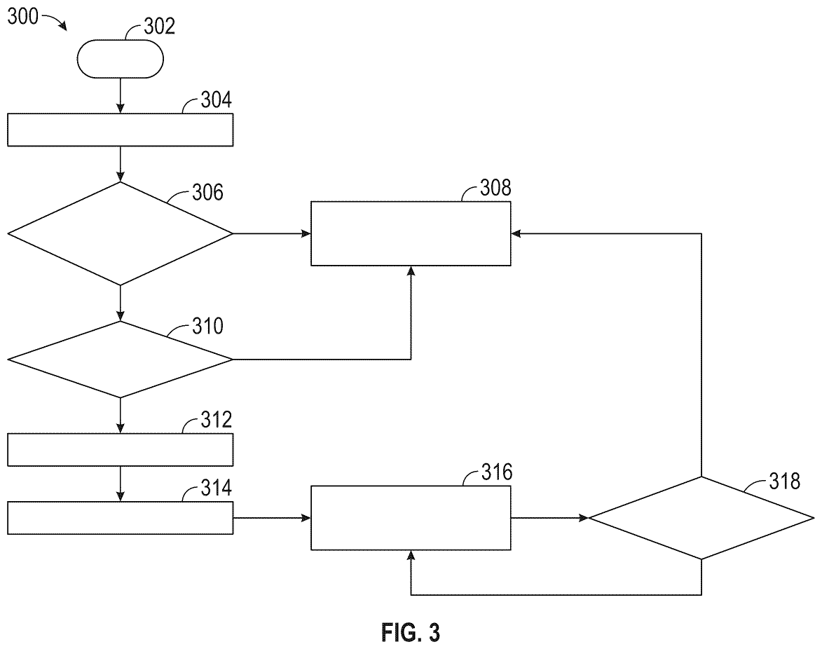

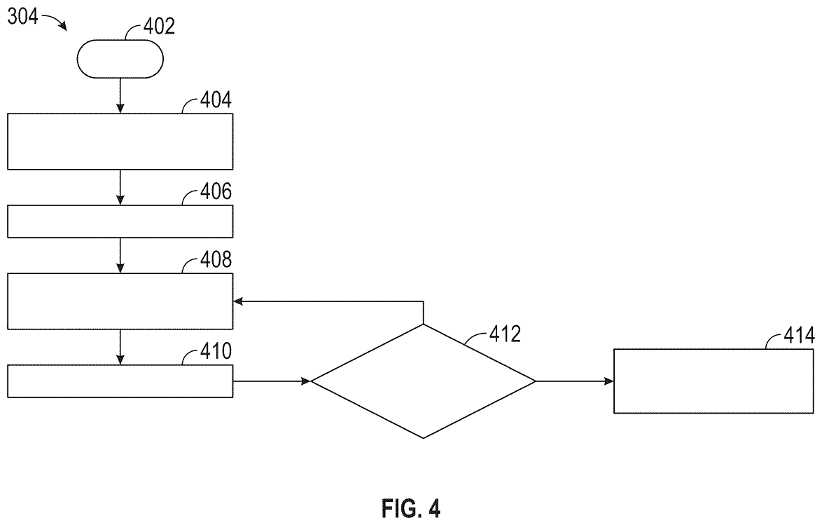

In various embodiments, the control system 102 controls adaptive cruise control, including driver leg comfort for adaptive cruise control, in accordance with the process 300 of FIGS. 3-4 and the implementations of FIGS. 2 and 5-8.

As depicted in FIG. 1, in various embodiments, the control system 102 includes a sensor array 120, a display system 130, and a controller 140, as described in greater detail below.

In various embodiments, the sensor array 120 includes various sensors that obtain sensor data as to the vehicle 100, including for use in providing cruise control functionality for the vehicle 100 and for driver leg comfort during cruise control. In the depicted embodiment, the sensor array 120 includes brake pedal sensors 122, accelerator pedal sensors 124, and input sensors 126. In certain embodiments, the sensor array 120 may also include one or more other sensors 128.

In various embodiments, the one or more brake pedal sensors 122 measure a driver's engagement of the brake pedal 107. In certain embodiments, the brake pedal sensors 122 measure brake pedal travel, brake pedal force, and/or one or more other measures of engagement of the brake pedal 107.

In various embodiments, the one or more accelerator pedal sensors 124 measure a driver's engagement of the accelerator pedal 115. In certain embodiments, the accelerator pedal sensors 124 measure accelerator pedal travel, accelerator pedal force, and/or one or more other measures of engagement of the accelerator pedal 115.

In various embodiments, the input sensors 126 receive inputs from the driver of the vehicle 100, including as to activation and deactivation of one or more cruise control features (including adaptive cruise control) and for adjusting driver settings for cruise control (such as for implementing a leg/foot rest feature for the accelerator pedal 115 during adaptive cruise control). In various embodiments, the input sensors 126 may be part of or coupled to the steering wheel 109, the display system 130 (e.g., a display screen thereof), or the like. In various embodiments, the input sensors 126 may comprise one or more buttons, switches, touch screen display sensors, or other sensors for a driver to provide inputs for the cruise control functionality and including comfort settings used in connection with the cruise control functionality.

In addition, in certain embodiments the sensor array 120 may also include one or more other sensors 128, such as one or more cameras, radar, Lidar, sonar, infrared, ultrasonic, and/or other types of sensors for implementation of adaptive cruise control, such as sensors for detecting objects and other vehicles, and speed sensors for cruise control operation, and the like.

In various embodiments, the display system 130 is configured to provide instructions, queries, alerts, settings, status, displays, and related information for the driver, including for cruise control functionality and the driver settings for the cruise control functionality. In various embodiments, the display system 130 includes a visual component including a display screen that provides visual notifications for the driver. In certain embodiments, the display system 130 may also include one or more audio components (e.g., including a speaker) that provides an audio notifications for the driver and/or one or more other components, such as a haptic component that provides one or more haptic notifications for the driver (e.g., by vibrating a seat of the driver).

In various embodiments, the controller 140 is coupled to the sensor array 120 and the display system 130, in addition to the braking system 106 and the drive system 110. In various embodiments, the controller 140 may also be coupled to the steering system 108 and/or one or more other vehicle systems. Also in various embodiments, the controller 140 comprises a computer system (also referred to herein as computer system 140), and includes a processor 142, a memory 144, an interface 146, a storage device 148, and a computer bus 150. In various embodiments, the controller (or computer system) 140 provides, among other functionality, the control of cruise control functionality, including driver leg/foot comfort during adaptive cruise control. In various embodiments, the controller 140 provides these and other functions in accordance with the steps of the process 300 of FIGS. 3 and 4 and the implementations of FIGS. 2 and 5-8.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 140 is part of and/or coupled to an engine control module (ECM), a body control module (BCM), and/or one or more other modules or systems of the vehicle 100. In certain other embodiments, the controller 140 and/or control system 102 and/or one or more components thereof may be disposed outside the body 104, for example on a remote server, in the cloud, or other device.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In various embodiments, the processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 300 of FIGS. 3 and 4 and the implementations of FIGS. 2 and 5-8.

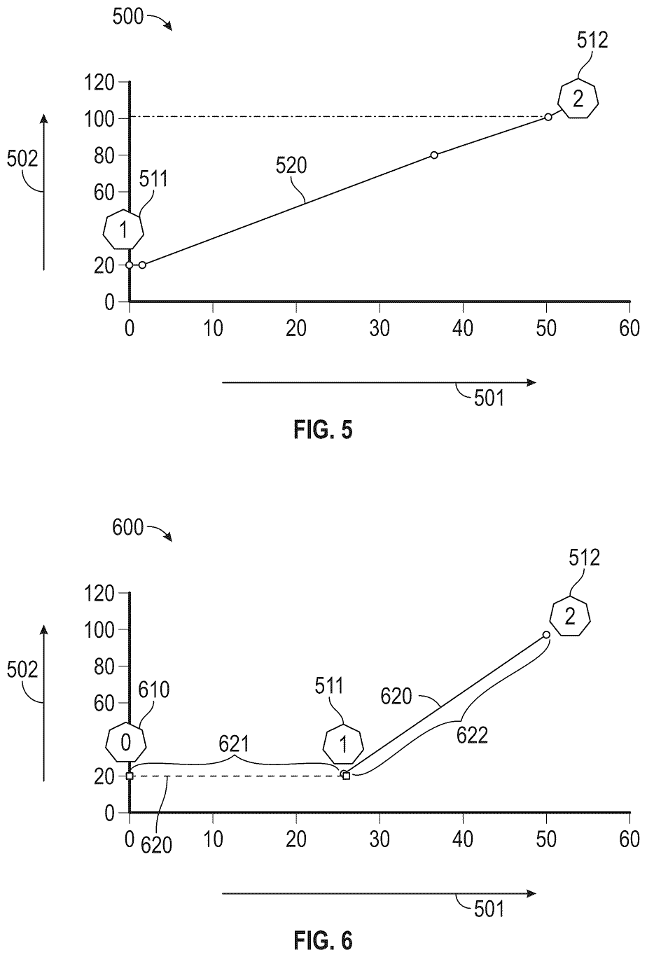

The memory 144 can be any type of suitable memory. For example, the memory 144 may include various types of dynamic random access memory (DRAM) such as synchronous dynamic random access memory (SDRAM), the various types of static RAM (SRAM), and the various types of non-volatile memory, such as programmable read-only memory (PROM) and flash. In certain examples, the memory 144 is located on and/or co-located on the same computer chip as the processor 142. In the depicted embodiment, the memory 144 stores the above-referenced program 152 along with stored values 157 (e.g., threshold values for the process 300 of FIGS. 3 and 4 and the implementations of FIGS. 5-8 in various embodiments).

The interface 146 allows communication to the computer system of the controller 140, for example from a system driver and/or another computer system, and can be implemented using any suitable method and apparatus. In one embodiment, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 300 of FIGS. 3 and 4 and the implementations of FIGS. 2 and 5-8. In another exemplary embodiment, the program product may be directly stored in and/or otherwise accessed by the memory 144 and/or a disk (e.g., disk 156), such as that referenced below.

The bus 150 serves to transmit programs, data, status and other information or signals between the various components of the computer system of the controller 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

FIG. 2 is a diagram of an implementation 200 of a portion of the vehicle 100 of FIG. 1 employed in connection with cruise control functionality, in accordance with exemplary embodiments. Specifically, FIG. 2 depicts a region 202 of the vehicle 100 in which the driver's feet/legs are positioned during a vehicle drive, including the accelerator pedal 115 and the brake pedal 107 of FIG. 1, along with a parking brake pedal 201, in an exemplary embodiment. As shown in FIG. 2, during adaptive cruise control, the controller 140 of FIG. 1 controls the adaptive cruise control functionality such that the driver may rest his or her leg (e.g., a foot thereof) in region 204 corresponding to the accelerator pedal 115. In this embodiment, the driver would still not touch the region 202 on or in proximity to the brake pedal 107 unless the driver wishes to override the adaptive cruise control and take manual control of the vehicle speed. In various embodiments, this is facilitated by the control system 102 in accordance with the steps of the process 300 and the implementations thereof as set forth in FIGS. 3-8 and described below in connection therewith.

FIG. 3 is a flowchart of a process 300 for controlling cruise control in a vehicle, including for driver leg comfort during adaptive cruise control, in accordance with exemplary embodiments. In various embodiments, the process 300 can be implemented in connection with the vehicle 100 and control system 102 of FIG. 1 and the implementation 200 of FIG. 2, in accordance with exemplary embodiments. The process 300 is described below in connection with FIG. 3 as well as FIG. 4 (which depicts an exemplary subroutine of the process 300 of FIG. 3) and FIGS. 5-8 (which depict exemplary implementations of the process 300).

As depicted in FIG. 3, in various embodiments, the process 300 begins at step 302. In one embodiment, the process 300 begins when a driver first enters the vehicle 100, for example for a vehicle drive. In one embodiment, the steps of the process 300 are performed continuously while the driver is inside the vehicle and/or during operation of the vehicle.

In various embodiments, settings are established for the vehicle (step 304). Specifically, in various embodiments, driver selections are received, recorded, and implemented with respect to the driver's preferences for operation of the cruise control functionality for the vehicle 100, including as to preferences with respect to resting of the driver's foot on the accelerator pedal during adaptive cruise control. In certain embodiments, the driver selections have been entered or previously stored (e.g., in a prior vehicle drive). In certain embodiments, the driver makes initial selections as to the driver's cruise control preferences the first time that the driver enters the vehicle 100, and these preferences are then stored in memory by the control system 102 of FIG. 1 for subsequent vehicle drives. In certain embodiments, the driver may also update the preferences as desired at the beginning of subsequent vehicle drives.

An exemplary subroutine for step 304 of the process 300 of FIG. 3 is depicted in the flowchart of FIG. 4, and is described directly below in connection therewith.

As depicted in FIG. 4, in various embodiments, the initiating of the settings begins at step 402, for example when the driver first enters the vehicle.

In various embodiments, drive inputs are obtained as to a leg free setting (step 404). Specifically, in certain embodiments, the driver selects one or more legroom settings using one or more input devices (e.g., on a center display of the display system 130 of FIG. 1 in certain embodiments), and inputs from the driver as to the legroom settings are obtained via one or more input sensors 126 of FIG. 1. In certain embodiments, the driver enters the desired percentage of accelerator pedal travel on the display. In various embodiments, this corresponds to a desired percentage or amount of accelerator pedal travel that will be allowed to be caused by the driver's leg/foot resting on the accelerator pedal during adaptive cruise control without causing the adaptive cruise control to be disengaged or otherwise changed (i.e., without causing an inadvertent increase in vehicle speed).

In certain embodiments, the leg free settings (also referred to as legroom settings), correspond to an extent of engagement of the accelerator pedal that the driver whishes to be able to apply to the accelerator pedal while resting the driver's leg/foot during adaptive cruise control operation of the vehicle 100, without causing disengagement of the adaptive cruise control feature. In various embodiments, the legroom setting corresponds to an amount of accelerator pedal travel to occur from the driver's leg/foot resting on the accelerator pedal and/or an amount of accelerator pedal force to be applied by the driver's leg/foot resting on the accelerator pedal without disengaging the adaptive cruise control (i.e., without causing an unintended increase in speed of the vehicle 100).

Also in various embodiments, the legroom settings are stored for future use (step 406). Specifically, in various embodiments, the processor 142 of FIG. 1 stores the driver's legroom settings in a computer memory (such as the memory 144 of FIG. 1) for use in the current vehicle drive as well as in future vehicle drives by the same driver along with personal identifying information for the driver. For example, in certain embodiments, the driver's legroom setting is saved along with a driver monitoring sensor, a particular keyfob of the driver, a particular cell phone of the driver, or the like, so that the driver's legroom settings can be automatically applied by the processor 142 in subsequent vehicle drive's based on an identification of the driver via identification of the driver's monitoring sensor, keyfob, cell phone, or the like.

Also in various embodiments, preferred seat positions for the driver are also obtained (step 408). For example, in certain embodiments, the driver is asked to move the driver seat to a desired position (e.g., in terms of distance from brake pedal and accelerator pedal, height, angle, lumbar support, and so on), and the driver inputs as to seat position are recorded via input sensors 126 of the sensor array 120 of FIG. 1. In various embodiments, the seat position inputs are saved by the processor 142 along with personally identifiable driver information in memory 144, similar to step 406 (e.g., along with identification of the driver's monitoring sensor, keyfob, cell phone, or the like).

In various embodiments, the driver preferences are displayed (step 410). Specifically, in various embodiments, the driver preferences as to the free legroom (i.e., of step 404) are displayed on a display screen of the display system 130 of FIG. 1 in accordance with instructions provided by the processor 142. For example, in certain embodiments, an accelerator pedal travel percentage or amount for free legroom is displayed on the display screen (e.g., on a center display of the vehicle 100) for approval by the driver. In certain embodiments, other user preferences (e.g., the seat position preferences of step 408) may similarly be displayed on the display screen of the display system 130 as part of step 410.

In various embodiments, a determination is made as to whether to save the driver inputs (step 412). Specifically, in certain embodiments, the input sensors 126 receive further driver inputs, in response to the display of step 410, as to whether the driver wishes for the current driver preferences of step 404 and 408 to be saved for future vehicle drives. In various embodiments, when the driver indicates that he or she does not wish to have the current driver preferences saved for future drives, then the process returns to either step 404 and/or step 408 (as appropriate) to obtain updated driver preference values, and the process continues. Also in various embodiments, once it is determined in an iteration of step 412 that the driver wishes to save the current driver preferences, then these driver preferences are stored in memory (e.g., the memory 144, as stored values 157 thereof) for use in future vehicle drives in which the driver is present in the driver seat of the vehicle 100.

With reference again to FIG. 3, in various embodiments, after the driver has entered the vehicle 100, a determination is made as to whether the driver has initiated adaptive cruise control (step 306). In various embodiments, the determination as to whether the driver has initiated adaptive cruise control is made by the processor 142 of FIG. 1 based on input sensor data that is obtained from one or more of the input sensors 126 of FIG. 1 (e.g., in certain embodiments, from the driver's engagement of one or more input devices or features of the steering wheel 109, display screen of the display system 130, or the like).

In various embodiments, when it is determined in step 306 that the driver has not initiated adaptive cruise control, then the vehicle 100 is operated in a standard or default mode, without activating adaptive cruise control, and without activating the free legroom feature (step 308). In various embodiments, during step 308, the processor 142 controls the drive system 110 of FIG. 1 using a standard or default operational mode for the accelerator pedal 115, for example such that any engagement (i.e., depression) of the accelerator pedal 115 will result in a corresponding increase in vehicle speed and any release of the accelerator pedal 115 will result in a corresponding device in vehicle speed.

With reference to FIG. 5, an illustration 500 is provided for the standard or default mode of operation for the accelerator pedal 115 in accordance with step 308, in accordance with an exemplary embodiment. Specifically, in the embodiment depicted in FIG. 5, pedal travel (in millimeters) is represented on an x-axis 501, whereas output signal (in percentage terms) is represented on a y-axis 502. The illustration also includes a graphical representation of a function 520 of the output signal versus the pedal travel. As represented in the function 520 of FIG. 5, the output signal increases (resulting in a corresponding increase in vehicle speed) approximately instantly when the accelerator pedal 115 is engaged, with an appropriate increase as the pedal travel increases from Point One (1) 511 to Point Two (2) 512 as depicted in FIG. 5. In this situation represented in FIG. 5, the driver is not able to rest his or her leg/foot on the accelerator pedal 115, as any engagement of the accelerator pedal 115 would result in an increased output signal and therefore an increased vehicle speed.

It is noted that while step 308 of FIG. 3 and the illustration 500 of FIG. 5 include the use of pedal travel of the accelerator pedal 115 as a threshold, in certain other embodiments the process 300 may instead use pedal force of the accelerator pedal 115 in a same or similar matter as pedal travel in various embodiments.

With reference back to step 306 of FIG. 3, in an exemplary embodiment, if it is instead determined in step 306 that the driver has initiated adaptive cruise control, then a determination is made as to whether the driver has initiated a request for free legroom activation (step 310). In various embodiments, this determination is made by the processor 142 of FIG. 1 based on input sensor data that is obtained from one or more of the input sensors 126 of FIG. 1 (e.g., in certain embodiments, from the driver's engagement of one or more input devices or features of the steering wheel 109 and/or display screen of the display system 130, or the like, pertaining to a free legroom request).

In various embodiments, if it is determined in step 310 that the driver has initiated a request for free legroom activation, then the free legroom feature is activated (step 312). Specifically, in various embodiments, the processor 142 of FIG. 1 provides a signal so that the free legroom feature is activated. In various embodiments, when the free legroom feature is activated, the driver is able to rest his or her leg/foot on the accelerator pedal 115 up to a predetermined amount of engagement (e.g., resulting in up to a predetermined amount of accelerator pedal 115 force and/or travel) without disengaging the adaptive cruise control (i.e., without resulting in an unintended increase in the vehicle speed). In various embodiments, the predetermined amount of engagement permitted while resting the leg/foot of the driver on the accelerator pedal 115 is based on the settings established in step 304 and stored in memory 144 as stored values 157, for example as described above in connection with the subroutine of FIG. 4. In certain embodiments, the settings were established in the current vehicle drive, whereas in certain other embodiments the settings were previously established in a prior vehicle drive (e.g., as described above in connection with FIG. 4).

With continued reference to FIG. 3, in various embodiments, the drive system 110 (e.g., as part of an engine control module in certain embodiments) then activates the free legroom feature (step 314) and controls the accelerator pedal 115 accordingly in a leg free acceleration mode (step 316) based on instructions related thereto that are provided by the processor 142. Specifically, in various embodiments, the processor 142 selectively controls a drive system 110 response to engagement of the accelerator pedal 115 to accommodate the driver's resting of a leg on the accelerator pedal 115 up to a certain magnitude while operating in the adaptive cruise control mode.

With reference to FIG. 6, an illustration 600 is provided for the leg free acceleration pedal mode of step 316, in accordance with an exemplary embodiment. Specifically, similar to FIG. 5, pedal travel (in millimeters) is represented on an x-axis 501, whereas output signal (in percentage terms) is represented on a y-axis 502.

However, FIG. 6 depicts a graphical representation of a different function 620 of the output signal versus the pedal travel. As represented in the function 620 of FIG. 6, there is a first segment 621 of the function 620 in which the output signal remains constant and does not increase when the accelerator pedal 115 is engaged, provided that the accelerator pedal 115 is not engaged (i.e., depressed) beyond a predetermined amount. Specifically, the output signal remains constant and does not increase (and therefore the vehicle speed remains constant and does not increase) when the pedal travel increase from Point Zero (0) 610 to Point One (1) 511 in FIG. 6. This represents accommodation of a resting position for the driver's leg/foot, such that the driver can rest his or her leg on the accelerator pedal 115 up to a predetermined amount (i.e., so that the pedal travel does not exceed the pedal travel value represented in Point One (1) 511 of FIG. 6) without any increase in output signal (i.e., without an unintended increase in vehicle speed). However, as shown FIG. 6, if the driver engagement of the accelerator pedal 115 results in pedal travel that exceeds that of Point One (1) 511 of FIG. 6, then after that point further increases in pedal travel will result in a greater output signal (and therefore greater vehicle speed), such as is shown in FIG. 6 for the second segment 622 of the function 620 between Point One (1) 511 and Point Two (2) 512 of FIG. 6. In various embodiments, while the free legroom feature is activated, the driver may also relieve pressure on the accelerator pedal 115 without disengaging the adaptive cruise and without changing the speed of the vehicle 100.

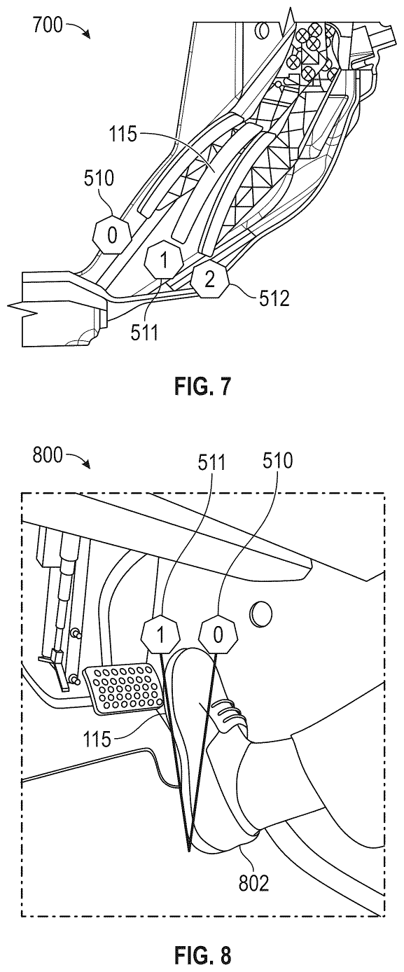

It is noted that while step 316 of FIG. 3 and the illustration 600 of FIG. 6 (as well as the discussion of FIGS. 7-9 below) include the use of pedal travel as a threshold, in certain other embodiments the process 300 may instead use pedal force of the accelerator pedal 115 in a same or similar matter as pedal travel in various embodiments. In addition, in certain embodiments, the free legroom feature activates via instructions provided by the processor 142 when one or more inputs provided by the driver (e.g., as detected via one or more inputs sensors 125) for at least a predetermined amount of time. In one such embodiment, the predetermined amount of time is equal to three seconds. Also in one embodiment, the free legroom feature activates via instructions provided by the processor 142 when an input sensor push button is pressed by the driver/operator of the vehicle 100 for more than three seconds.

With reference to FIGS. 7 and 8, respective implementations 700 and 800, respectively, are depicted with respect to the respective Point Zero (0) 610, Point One (1) 511, and Point Two (2) 512, particularly as implemented in the embodiment of FIG. 6 for the leg free acceleration pedal mode of step 316. As referenced in FIGS. 7 and 8, in an exemplary embodiment: (i) Point Zero (0) 510 represents a condition in which the leg (e.g., foot 802 thereof) of the driver (e.g., as shown in FIG. 8) does not contact the accelerator pedal 115; and (ii) Point One (1) represents a condition in which the leg (e.g., foot 802 thereof) of the driver contacts the accelerator pedal 115 by an amount that is less than a predetermined threshold (i.e., such that the leg (e.g., foot 802 thereof) is allowed to rest without causing an increase in output signal and a corresponding increase in vehicle speed). In addition, FIG. 7 depicts Point Two (2) 512, which represents a greater pedal travel as compared with both Point Zero (0) 610 and Point One (1) 511, such that the output signal (and therefore the vehicle speed) increases when the magnitude of accelerator pedal engagement (e.g., in terms of pedal travel) is between Point One (1) 511 and Point Two (2) 512. In certain embodiments, Point Two (2) 512 represents a maximum engagement of the accelerator pedal 115 (e.g., corresponding to a maximum accelerator pedal travel).

Similar to the discussion above, in various embodiments the relationship between pedal travel and output signal of FIG. 6 may be calibrated by the driver, for example by tuning the value of Point One (1) (namely, the amount of pedal travel that would be needed to be treated as an increase in output signal rather than resting of the leg on the accelerator pedal 115 of FIG. 6) as part of step 304 of FIGS. 3 and 4 in various embodiments.

With reference back to FIG. 3, as the free legroom feature is utilized in step 316, a determination is made as to whether the free legroom feature is to be terminated (step 318). Specifically, in various embodiments, the determination of whether the free legroom feature is to be terminated is made by the processor 142 based on inputs that are provided by the driver and received via the input sensors 126 of FIG. 1. Specifically, in certain embodiments, the free legroom feature is to be terminated when the driver takes one or more actions indicating that the free legroom feature is no longer appropriate and/or is no longer desired by the driver. Specifically, in certain embodiments, the free legroom feature is to be terminated when any one or more of the following conditions have occurred, namely: (i) the driver has turned off or deactivated adaptive cruise control; (ii) the driver has engaged the brake pedal 107; (iii) the driver has engaged the accelerator pedal 115 by more than a predetermined threshold (e.g., resulting in greater percentage or amount of accelerator pedal travel and/or accelerator pedal force than the threshold percentage or amount set by the driver in step 304 and in the subroutine thereof of FIG. 4); or (iv) the driver has engaged the accelerator pedal 115 in a fast and repetitive manner (e.g., such that the accelerator pedal 115 is engaged by the driver for greater than a first predetermined number of engagements (i.e., greater than a first predetermined threshold for the number of engagements) within an amount of time that is less than a predetermined duration of time (i.e., within an amount of time that is less than a second predetermined threshold for the amount of time).

In various embodiments, if it is determined during step 318 that the free legroom feature is determined to be terminated, then the leg free acceleration pedal mode of step 316 is terminated, and the process 300 returns to step 308 as the standard or default acceleration pedal mode is implemented. The process 300 then continues until a subsequent determination is made that the free legroom feature is to be reactivated.

Conversely, in various embodiments, if it is instead determined during step 318 that the free legroom feature is not to be terminated, then the leg free acceleration pedal mode of step 316 continues, and the free legroom feature continues until a subsequent determination is made that the free legroom feature is to be terminated (e.g., when the driver deactivates adaptive cruise control and/or the free legroom feature via one of the actions set forth above in connection with step 318).

Accordingly, methods, systems, and vehicles are disclosed for controlling cruise control for vehicles. Specifically, in various embodiments, when an adaptive cruise control feature is activating along with a free legroom feature thereof, the accelerator pedal is controlled in a manner that allows the driver to rest his or leg (and foot thereof) on the accelerator pedal up to a certain predetermined magnitude (e.g., in terms of accelerator pedal travel or accelerator pedal force) without deactivating the adaptive cruise control and without resulting in an unintended increase in vehicle speed. While the techniques are discussed above primarily with respect to adaptive cruise control (e.g., in which vehicle speed is automatically adjusted to maintain a predetermined distance from other vehicles in certain embodiments), it will be appreciated that in certain embodiments these may also be implemented in connection with other cruise control features, including a cruise control feature in which a constant speed is maintained, among other possible cruise control features and settings.

It will be appreciated that the systems, vehicles, and methods may vary from those depicted in the Figures and described herein. For example, the vehicle 100 of FIG. 1, the control system 102 of FIG. 1, and/or components thereof may vary in different embodiments. It will similarly be appreciated that the steps of the process 300 (and subroutine thereof) may differ from that depicted in FIGS. 3 and 4, and/or that various steps of the process 300 may occur concurrently and/or in a different order than that depicted in FIGS. 3 and 4. It will also be appreciated that the implementations of FIGS. 2 and 5-8 may also vary in different embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining, via one or more input sensors of a vehicle, inputs from a driver as to initiation of a cruise control feature and a free legroom feature for the vehicle;
obtaining, via one or more accelerator pedal sensors coupled to an accelerator pedal of the vehicle, a measure of engagement of the accelerator pedal by the driver; and
selectively controlling, via a processor of the vehicle based on the inputs and the measure of engagement of the accelerator pedal, a response of a drive system of the vehicle to the engagement of the accelerator pedal when the cruise control feature and the free legroom feature of the vehicle are both activated based on the inputs, such that a speed of the vehicle will not increase based on the engagement of the accelerator pedal that is less than a predetermined threshold.

2. The method of claim 1, wherein the cruise control feature comprises adaptive cruise control for the vehicle.

3. The method of claim 2, wherein:
the predetermined threshold comprises a predetermined travel threshold for accelerator pedal travel of the accelerator pedal;
when the accelerator pedal travel exceeds the predetermined travel threshold, a signal output for the accelerator pedal increases, such that the speed of the vehicle increases as a result of the engagement of the accelerator pedal by the driver; and
when the accelerator pedal travel does not exceed the predetermined travel threshold, the signal output for the accelerator pedal remains constant, such that the speed of the vehicle does not increase, and the driver can rest a leg on the accelerator pedal during the adaptive cruise control.

4. The method of claim 3, further comprising:
tuning, via the processor, the predetermined travel threshold based on the inputs provided by the driver and obtained via the one or more input sensors for settings for the free legroom feature of the adaptive cruise control.

5. The method of claim 4, wherein the free legroom feature activates via instructions provided by the processor when an input sensor push button is pressed for more than three seconds.

6. The method of claim 4, further comprising:
storing the settings for the driver into memory, via the processor, along with information for identification of the driver, for use in subsequent vehicle drives.

7. The method of claim 2, wherein:
the predetermined threshold comprises a predetermined force threshold for accelerator pedal force of the accelerator pedal;
when the accelerator pedal force exceeds the predetermined force threshold, a signal output for the accelerator pedal increases, such that the speed of the vehicle increases as a result of the engagement of the accelerator pedal by the driver; and
when the accelerator pedal force does not exceed the predetermined force threshold, the signal output for the accelerator pedal remains constant, such that the speed of the vehicle does not increase, and the driver can rest a leg on the accelerator pedal during the adaptive cruise control.

8. The method of claim 7, further comprising:
tuning, via the processor, the predetermined force threshold based on the inputs provided by the driver and obtained via the one or more input sensors for settings for the free legroom feature of the adaptive cruise control; and
storing the settings for the driver into memory, via the processor, along with information for identification of the driver, for use in subsequent vehicle drives.

9. The method of claim 2, further comprising:
disengaging the free legroom feature, via the processor, upon occurrence of one or more of the following conditions: (i) the driver has turned off or deactivated the adaptive cruise control; (ii) the driver has engaged a brake pedal of the vehicle; (iii) the driver has engaged the accelerator pedal by an amount that is more than the predetermined threshold amount resulting in accelerator pedal travel that is greater than a predetermined pedal travel threshold; or (iv) the driver has engaged the accelerator pedal for greater than a predetermined number of engagements within an amount of time that is less than a predetermined duration of time.

10. A system comprising:
one or more input sensors of a vehicle that are configured to obtain inputs from a driver as to initiation of a cruise control feature and a free legroom feature for the vehicle;
one or more accelerator pedal sensors that are coupled to an accelerator pedal of the vehicle and that are configured to obtain a measure of engagement of the accelerator pedal by the driver; and
a processor of the vehicle that is coupled to the one or more input sensors and to the one or more accelerator pedal sensors, and that is configured to at least facilitate selectively controlling, based on the inputs and the measure of engagement of the accelerator pedal, a response of a drive system of the vehicle to the engagement of the accelerator pedal when the cruise control feature and the free legroom feature of the vehicle are both activated based on the inputs, such that a speed of the vehicle will not increase based on the engagement of the accelerator pedal that is less than a predetermined threshold.

11. The system of claim 10, wherein the cruise control feature comprises adaptive cruise control for the vehicle.

12. The system of claim 11, wherein:
the predetermined threshold comprises a predetermined travel threshold for accelerator pedal travel of the accelerator pedal;
when the accelerator pedal travel exceeds the predetermined travel threshold, the processor is configured to at least facilitate increasing a signal output for the accelerator pedal, such that the speed of the vehicle increases as a result of the engagement of the accelerator pedal by the driver; and
when the accelerator pedal travel does not exceed the predetermined travel threshold, the processor is configured to at least facilitate keeping the signal output for the accelerator pedal constant, such that the speed of the vehicle does not increase, and the driver can rest a leg on the accelerator pedal during the adaptive cruise control.

13. The system of claim 12, wherein the processor is further configured to at least facilitate tuning the predetermined travel threshold based on the inputs provided by the driver and obtained via the one or more input sensors for settings for the free legroom feature of the adaptive cruise control.

14. The system of claim 13, wherein the free legroom feature activates via instructions provided by the processor when an input sensor push button is pressed for more than three seconds.

15. The system of claim 13, wherein the processor is further configured to at least facilitate storing the settings for the driver into memory along with information for identification of the driver, for use in subsequent vehicle drives.

16. The system of claim 11, wherein:
the predetermined threshold comprises a predetermined force threshold for accelerator pedal force of the accelerator pedal;
when the accelerator pedal force exceeds the predetermined force threshold, the processor is configured to at least facilitate increasing a signal output for the accelerator pedal, such that the speed of the vehicle increases as a result of the engagement of the accelerator pedal by the driver; and
when the accelerator pedal force does not exceed the predetermined force threshold, the processor is configured to at least facilitate keeping the signal output for the accelerator pedal constant, such that the speed of the vehicle does not increase, and the driver can rest a leg on the accelerator pedal during the adaptive cruise control.

17. The system of claim 16, wherein the processor is further configured to at least facilitate:
tuning the predetermined force threshold based on the inputs provided by the driver and obtained via the one or more input sensors for settings for the free legroom feature of the adaptive cruise control; and
storing the settings for the driver into memory, along with information for identification of the driver, for use in subsequent vehicle drives.

18. The system of claim 11, wherein the processor is further configured to at least facilitate disengaging the free legroom feature, upon occurrence of one or more of the following conditions: (i) the driver has turned off or deactivated the adaptive cruise control; (ii) the driver has engaged a brake pedal of the vehicle; (iii) the driver has engaged the accelerator pedal by an amount that is more than the predetermined threshold amount resulting in accelerator pedal travel that is greater than a predetermined pedal travel threshold; or (iv) the driver has engaged the accelerator pedal for greater than a predetermined number of engagements within an amount of time that is less than a predetermined duration of time.

19. A vehicle comprising:
a body;
a drive system configured to move the body;
an accelerator pedal coupled to the drive system;
one or more input sensors that are configured to obtaining inputs from a driver as to initiation of an adaptive cruise control and a free legroom feature for the vehicle;
one or more accelerator pedal sensors that are coupled to the accelerator pedal and that are configured to obtain a measure of engagement of the accelerator pedal by the driver; and
a processor of the vehicle that is coupled to the one or more input sensors and to the one or more accelerator pedal sensors, and that is configured to at least facilitate:
selectively controlling, based on the inputs and the measure of engagement of the accelerator pedal, a response of the drive system to the engagement of the accelerator pedal when the adaptive cruise control and the free legroom feature of the vehicle are both activated based on the inputs, such that a speed of the vehicle will not increase based on the engagement of the accelerator pedal that is less than a predetermined threshold, wherein:
the predetermined threshold comprises a predetermined travel threshold for accelerator pedal travel of the accelerator pedal;
when the accelerator pedal travel exceeds the predetermined travel threshold, the processor is configured to at least facilitate increasing a signal output for the accelerator pedal, such that the speed of the vehicle increases as a result of the engagement of the accelerator pedal by the driver; and
when the accelerator pedal travel does not exceed the predetermined travel threshold, the processor is configured to at least facilitate keeping the signal output for the accelerator pedal constant, such that the speed of the vehicle does not increase, and the driver can rest a leg on the accelerator pedal during the adaptive cruise control.

20. The vehicle of claim 19, wherein the processor is further configured to at least facilitate:
tuning the predetermined travel threshold based on the inputs provided by the driver and obtained via the one or more input sensors for settings for the free legroom feature of the adaptive cruise control;
storing the settings for the driver into memory along with information for identification of the driver, for use in subsequent vehicle drives; and
disengaging the free legroom feature, upon occurrence of one or more of the following conditions: (i) the driver has turned off or deactivated the adaptive cruise control; (ii) the driver has engaged a brake pedal of the vehicle; (iii) the driver has engaged the accelerator pedal by more than a predetermined threshold amount resulting in the accelerator pedal travel that is greater than a predetermined pedal travel threshold; or (iv) the driver has engaged the accelerator pedal for greater than a predetermined number of engagements within an amount of time that is less than a predetermined duration of time.
